(19) United States
(12) Patent Application Publication
(10) Pub. No.: US 2010/0171656 A1
(43) Pub. Date: Jul. 8, 2010

(54) Electronic apparatus and image display method

(75) Inventor: Yin-He Zhang, Guishan Shanghai (CN)

Correspondence Address: BACON & THOMAS, PLLC, 625 SLATERS LANE, FOURTH FLOOR, ALEXANDRIA, VA, 22314-1176, US

(73) Assignee: Mitac International Corp., Taoyuan County (TW)

(21) Appl. No.: 12/458,925

(22) Filed: Jul. 28, 2009

(30) Foreign Application Priority Data
Jan. 6, 2009 (TW) 098118021

(51) Int. Cl. G01S 1/00

(52) U.S. Cl. 342/357.09

(57) ABSTRACT

The invention discloses an electronic apparatus. The electronic apparatus includes a storage module, a receiving module, a processing module, and a display module. The storage module is used to store a plurality of image data, and each image data has a corresponding coordinate data. The receiving module is used to receive a positioning data related to the electronic apparatus. The processing module is used to select at least one image data according to the positioning data and the coordinate data. The display module is used to display the at least one image data.

### BACKGROUND OF THE INVENTION

1. Field of the invention

This invention relates to an electronic apparatus and an image display method, and more particularly to the electronic apparatus and the image display method capable of changing wallpapers according to different places.

2. Description of the related art

With the advances in technologies, users can carry electronic apparatuses (e.g., a laptop, PDA, or a popular cell phone in the market, etc) anytime and anywhere. To carry the electronic apparatuses on the go, the electronic apparatuses almost satisfy the basic requirements of lighter, thinner, and smaller.

After the electronic apparatuses can be carried about by everyone, the next goal is for users to transfer and receive various kinds of information with the electronic apparatuses on the go. Since the wireless network is gradually becoming available to all, everyone can obtain various kinds of information anytime and anywhere. For example, users can watch network TV channels or browse the news by accessing the Internet with cell phones, which can let users search certain information rapidly. For example, if users want to get the weather information when they are outside for work or go on a business trip, they can use cell phones to search.

Furthermore, besides having wireless network receivers to receive electronic information, there are many electronic apparatuses which can use the function of GPS (Global Position System). The electronic apparatuses will have many different applications while having GPS functionality. For example, the applications can be path-finding or path-planning.

However, although the electronic apparatuses include many different functions, users will feel bored and then affect the users' mood after seeing the same wallpapers displayed on their electronic apparatuses for a long time. Moreover, although the wallpapers of nearly all electronic apparatus can be changed by user, these processes are very troublesome.

Accordingly, the invention is to provide an electronic apparatus which can change wallpapers according to different places. When a user is from a place to a different place, the wallpaper of the electronic apparatus will change accordingly. Therefore, the user will not feel bored seeing the same wallpaper. Additionally, the wallpaper displayed on the electronic apparatus is automatically changed according to different places without manually changing repeatedly. Thus, the electronic apparatuses are not only convenient and interesting but also can increase the value of the product, such as the consumers' desire to buy the product.

### SUMMARY OF THE INVENTION

A scope of the invention is to provide an electronic apparatus. The electronic apparatus includes a storage module, a receiving module, a processing module, and a display module. The storage module is used to store a plurality of image data, wherein each image data has a corresponding coordinate data. The receiving module is used to receive a positioning data related to the electronic apparatus. Wherein, the positioning data is a transient coordinate data of the electronic apparatus and complies with the format of GPS (Global Positioning System).

The processing module is connected to the storage module and the receiving module for selecting at least one image data according to the positioning data and the coordinate data. Additionally, the processing module further generates a searching region based on the positioning data and selects the at least one image data according to the searching region and the coordinate data. The display module is connected to the processing module and the storage module for displaying the at least one image data. Particularly, the display module displays the at least one image data according to a criterion, wherein the criterion further includes a display order and a display time.

Another scope of the invention is to provide an image display method which can be applied to an electronic apparatus. The electronic apparatus includes a storage module and a display module, wherein the storage module stores a plurality of image data, and each image data has a corresponding coordinate data. The image display method includes the steps of:

(a) receiving a positioning data related to the electronic apparatus;

(b) selecting at least one image data according to the positioning data and the coordinate data; and

(c) displaying the at least one image data on the display module.

Compared with prior arts, the wallpaper of the electronic apparatus of the invention can be changed with different places. Therefore, the user will not feel bored about the same wallpaper. Additionally, the wallpaper displayed on the electronic apparatus is automatically changed according to different places without repeatedly changing it manually.

The advantage and spirit of the invention may be understood by the following recitations together with the appended drawings.

### BRIEF DESCRIPTION OF THE APPENDED DRAWINGS

FIG. 1 is a block diagram illustrating the electronic apparatus according to an embodiment of the invention.

FIG. 2 is a flow chart diagram showing the image display method according to an embodiment of the invention.

### DETAILED DESCRIPTION OF THE INVENTION

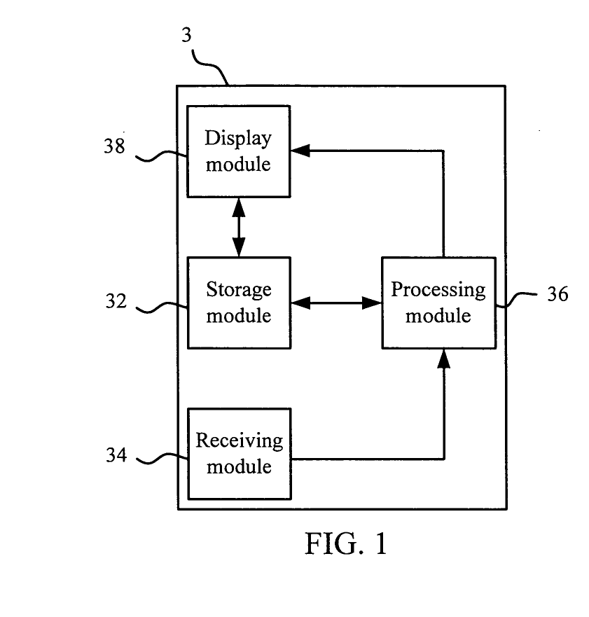

Please refer to FIG. 1. FIG. 1 is a block diagram illustrating the electronic apparatus 3 according to an embodiment of the invention. As shown in FIG. 1, the electronic apparatus 3 of the invention includes a storage module 32, a receiving module 34, a processing module 36, and a display module 38.

The storage module 32 is used to store a plurality of image data, wherein each image data has a corresponding coordinate data. The receiving module 34 is used to receive a positioning data related to the electronic apparatus 3. Particularly, the positioning data is a transient coordinate data of the electronic apparatus 3, and the positioning data complies with the GPS (Global Positioning System) format. The processing module 36 is connected to the storage module 32 and the receiving module 34 for selecting at least one image data which is stored in the storage module 32 according to the positioning data and the coordinate data. The display module 38 is connected to the processing module 36 and the storage module 32 for displaying the at least one image data as a background image of the display module 38 of the electronic apparatus 3.

The connection relationships among all modules of the electronic apparatus 3 of the invention are explained and described in detail above. The practical operation processes and approaches of the electronic apparatus 3 of the invention will be described in detail below.

Please refer to FIG. 1. As shown in FIG. 1, the electronic apparatus 3 includes the storage module 32, the receiving module 34, the processing module 36, and the display module 38. Particularly, the electronic apparatus 3 can be, but is not limited to, a cell phone or a laptop. The electronic apparatus 3 will take the cell phone for example below.

In practical application, the cell phone can include a build-in digital camera for taking digital images. For example, when the famous Taipei 101 building is photographed by the cell phone, the image data of Taipei 101 can be stored in the storage module 32. Meanwhile, the receiving module 34 can receive the coordinate position of the position of the cell phone through GPS (define to position data). Then the coordinate position will be defined as the coordinate data of the image data of Taipei 101. By using the same method, the user can carry the cell phone to the National Dr. Sun Yat-sen Memorial Hall and take a picture of the National Dr. Sun Yat-sen Memorial Hall. Meanwhile, the receiving module 34 can also receive a coordinate position of the cell phone through GPS which can be defined as the coordinate data of the image data of the National Dr. Sun Yat-sen Memorial Hall.

Particularly, the method of defining the coordinate position of the cell phone is not limited to get the GPS coordinate position, another method for positioning (for example, positioning the current coordinate of the cell phone by the station) still exists. A table in which the data comply with the foregoing method is listed below.

TABLE 1

| Image data | Number | Coordinate data |
|---|---|---|
| Taipei 101 | 001 | (100, 200) |
| National Dr. Sun | 002 | (250, 300) |
| Yat-sen Memorial | | |
| Hall | | |
| Shin Kong | 003 | (400, 400) |
| Mitsukoshi store | | |
| Taipei World Trade | 004 | (550, 500) |
| Center | | |

As shown in Table 1, each place can be assigned a number by the user (e.g., the number for Taipei 101 can be defined as 001). In practical application, when the user carries the cell phone and moves anywhere, the receiving module 34 can continuously receive the positioning data related to the coordinate of the place of the cell phone. Then, the processing module 36 which is disposed in the cell phone can analyze and compare the positioning data received by the receiving module 34 and the coordinate data stored in the storage module 32, so as to select the suitable image data and transmit the related signal to the display module 38 to display the suitable image data.

For example, please refer to Table 1. The cell phone now receives a coordinate position (400,400). The coordinate position (400,400) will be compared with the coordinate data stored in the storage module 32 by the processing module 36, to obtain the image data of the number 003. When the processing module 36 selects the image data which complies with the positioning data from the storage module 32, the signal will be transmitted to the display module 38. The display module 38 then reads out the image data of the number 003 from the storage module 32 according to the information provided by the processing module 36. The image data can be shown as a background image displayed on the panel of the display module 38 for users to watch. That is to say, the background image is a still image. Particularly, the panel of the display module 38 can also display a foreground image, and the foreground image is displayed in front of the background image, wherein the foreground image can be, but is not limited to, operation pictures of a certain application program. That is to say, the foreground image is a dynamic image.

Additionally, users can also define the searching region manually to display the image data of the current location of the cell phone. For example, the searching region can be defined from −100 to 100 in both X and Y coordinates. Furthermore, when the differences between the X coordinates and Y coordinates of the positioning data and those of the coordinates positioning within the range from −100 to 100, the processing module 36 will select the signal which matches the condition and transform to the display module 38. At the same time, the display module 38 reads out image data which complies with the condition from storage module 32 according to the signal and display it on the panel.

For example, when the coordinate of the positioning data received by the receiving module 34 of the cell phone is (150,250), the processing module 36 can be compared with the positioning data of the coordinate data and select the coordinate data within the range from −100 to 100 of the positioning data. It can be easily known from table 1 that the coordinate data of number 001 and that of number 002 match the foregoing condition. Therefore, the processing module 36 transmits the signal of selecting the image data of number 001 and that of number 002. While receiving the signal from the processing module 36, the display module 38 will select the image data of number 001 and that of number 002 which are stored in the storage module 32 and display them on the panel.

Particularly, when the display module 36 selects two different image data at the same time, the display module 36 can then display the image data according to the criterion defined by the user. For example, when there are two image data selected, the image data with smaller number can be displayed with higher priority according to the criterion defined by the user, and the criterion can be further defined to make the display period of each image data is 1 min. The order or the period of displaying image data related of the criterion can be defined by the user without any limitation.

In practical application, when the user moves to the vicinity of Taipei 101, the wallpaper of the cell phone will automatically change to the image of Taipei 101. If the user is located in the vicinity of Shin Kong Mitsukoshi store and Taipei World Trade Center, the wallpaper of the cell phone may display the image of Taipei World Trade Center and display the image of Shin Kong Mitsukoshi store 1 min later.

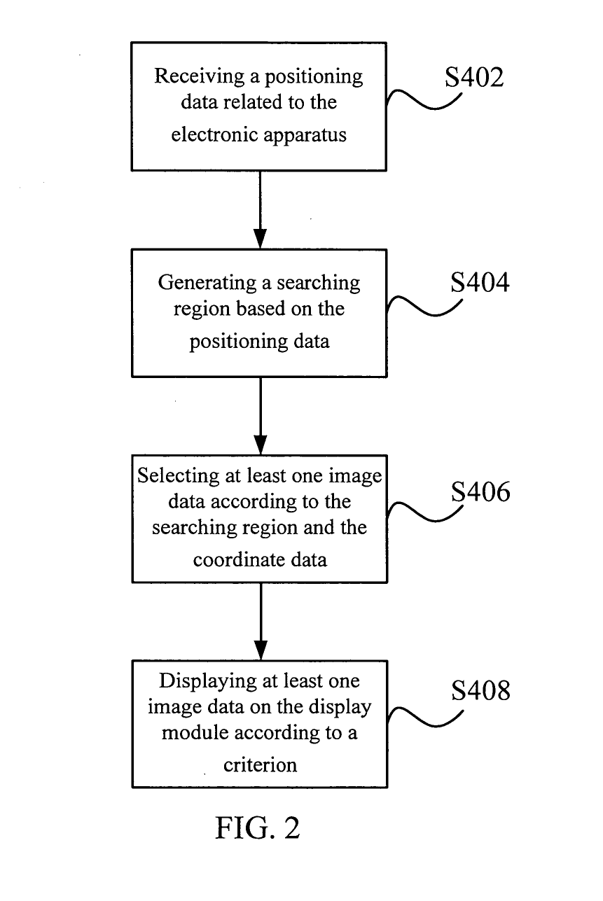

Please refer to PIG. 2. FIG. 2 is a flow chart diagram showing the image display method according to an embodiment of the invention. The image display method of the invention can be applied to an electronic apparatus. The electronic apparatus includes a storage module and a display module, wherein the storage module stores a plurality of image data, and each image data have a corresponding coordinate data. The image display method includes the steps of:

Step S402: receiving a positioning data related to the electronic apparatus.

Step S404: generating a searching region based on the positioning data.

Step S406: selecting the at least one image data according to the searching region and the coordinate data.

Step S408: displaying the at least one image data on the display module according to a criterion.

The operation in practical application and the conception of the image display method are the same with the foregoing descriptions, so they will not be redundantly explained here.

Compared with prior arts, the wallpaper of the electronic apparatus of the invention can be changed according to different places. Therefore, the user will not feel bored with the same wallpaper. Additionally, the wallpaper displayed on the electronic apparatus is automatically changed according to different places without repeatedly changing it manually. Thus, the electronic apparatuses are not only convenient and interesting but also can increase the value, such that the consumers' desire to buy the product.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as being limited only by the metes and bounds of the appended claims.

What is claimed is:

1. An electronic apparatus, comprising:
a storage module for storing a plurality of image data, wherein each image data has a corresponding coordinate data;
a receiving module for receiving a positioning data related to the electronic apparatus;
a processing module, connected to the storage module and the receiving module, for selecting at least one image data according to the positioning data and the coordinate data; and
a display module, connected to the processing module and the storage module, for displaying the at least one image data as a background image of the display module.

2. The electronic apparatus of claim 1, wherein the positioning data is a transient coordinate data of the electronic apparatus.

3. The electronic apparatus of claim 1, wherein the positioning data complies with the GPS (Global Positioning System) format.

4. The electronic apparatus of claim 1, wherein the processing module further generates a searching region based on the positioning data and selects the at least one image data according to the searching region and the coordinate data.

5. The electronic apparatus of claim 1, wherein the display module displays the at least one image data according to a criterion.

6. The electronic apparatus of claim 5, wherein the criterion further comprises a display order and a display time.

7. An image display method being applied to an electronic apparatus, the electronic apparatus comprising a storage module and a display module, storage module storing a plurality of image data, each image data having a corresponding coordinate data, the image display method comprising the steps of:
(a) receiving a positioning data related to the electronic apparatus;
(b) selecting at least one image data according to the positioning data and the coordinate data; and
(c) displaying the at least one image data on the display module;

8. The image display method of claim 7, wherein the positioning data is a transient coordinate data of the electronic apparatus.

9. The image display method of claim 7, wherein the positioning data complies with the GPS (Global Positioning System) format.

10. The image display method of claim 7, wherein step (b) further comprises the steps of:
(b1) generating a searching region based on the positioning data; and
(b2) selecting the at least one image data according to the searching region and the coordinate data.

11. The image display method of claim 7, wherein step (c) further comprises the step of:
(c1) displaying the at least one image data on the display module according to a criterion.

12. The image display method of claim 11, wherein the criterion further comprises a display order and a display time.
